(19) United States
(12) Patent Application Publication
(10) Pub. No.: US 2013/0117173 A1
(43) Pub. Date: May 9, 2013

(54) Method and System of Increasing Credit Score of a Borrower

(71) Applicants: Stanley G. SCHWARZ, Indialantic, FL (US); Gerald A. MORGAN, Littleton, CO (US); Jeffrey H. FRANK, Littleton, CO (US); Christopher M. MACHECA, Centennial, CO (US); Alan E. VORDERMEIER, JR., Charlotte, NC (US)

(72) Inventors: Stanley G. SCHWARZ, Indialantic, FL (US); Gerald A. MORGAN, Littleton, CO (US); Jeffrey H. FRANK, Littleton, CO (US); Christopher M. MACHECA, Centennial, CO (US); Alan E. VORDERMEIER, JR., Charlotte, NC (US)

(73) Assignee: GORDON*HOWARD ASSOCIATES, INC., Littleton, CO (US)

(21) Appl. No.: 13/291,723

(22) Filed: Nov. 8, 2011

(51) Int. Cl. G06Q 40/02

(52) U.S. Cl. 705/38

(57) ABSTRACT

Increasing credit score of a borrower. At least some of the illustrative embodiments are methods including: accepting an application from a borrower, the application for a motor vehicle loan, and the application accepted by way of an electronic submission to a data center; determining that the borrower has an indicia of credit worthiness below a predetermined threshold, the determining by way of a computer system of the data center; offering the borrower a first loan with a requirement that a first motor vehicle purchased with the first loan comprise a first on-board device configured to provide location of the first motor vehicle; and if the borrower accepts tracking the loan payments made by the borrower, the tracking by way of a computer system; and reporting loan payments to a credit reporting agency, the reporting by way of a computer system.

### BACKGROUND

Individuals with low credit scores have difficulty financing purchases, such as purchases of automobiles. To the extent such individuals can find companies to finance automobile purchases, many times the financing is through a “buy here, pay here” automobile dealer where the purchaser makes payments directly at the automobile dealer's location. Such loans are often called “sub-prime” because the borrowers are not in the “prime” category of borrower.

Sub-prime loans often have shortened payment cycles (e.g., weekly, bi-weekly), and sub-prime loans often have higher interest rates, many times ten percentage points or more higher than a “prime” borrower, the higher interest rates owing to the higher perceived risk associated with a sub-prime loan. Though unfortunate for the sub-prime borrower, “buy here, pay here” automobile dealers have no incentive to help a borrower improve their credit score. Even though a borrower may have effectively become a candidate for a “prime” loan by way of consistent loan payments, the “buy here, pay here” automobile dealers have little incentive to re-finance the borrower at a lower rate or help the borrower transition to a “prime” borrower by way of credit reporting, because of the high interest rate received.

### BRIEF DESCRIPTION OF THE DRAWINGS

For a detailed description of exemplary embodiments, reference will now be made to the accompanying drawings in which:

FIG. 1 shows a system in accordance with at least some embodiments;

FIG. 2 shows a system in accordance with at least some embodiments;

FIG. 3 shows a method in accordance with at least some embodiments; and

FIG. 4 shows a computer system in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

“About”, with respect to credit score, shall mean a credit score within five percent (5%) of the recited value.

“Remote” or “remotely”, relative to a vehicle, shall mean a distance of greater than one kilometer.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure or claims. In addition, one skilled in the art will understand that the following description has broad application, and the discussion of any embodiment is meant only to be exemplary of that embodiment, and not intended to intimate that the scope of the disclosure or claims is limited to that embodiment.

The various embodiments are directed to systems and methods of accepting applications for purchases to be financed, financing the purchases, and tracking the assets (e.g., automobiles). One result of the unique and innovative system is, assuming consistent loan payments by the borrower, the borrower's credit score may be increased, which may then qualify the borrower for future loans, at more favorable interest rates.

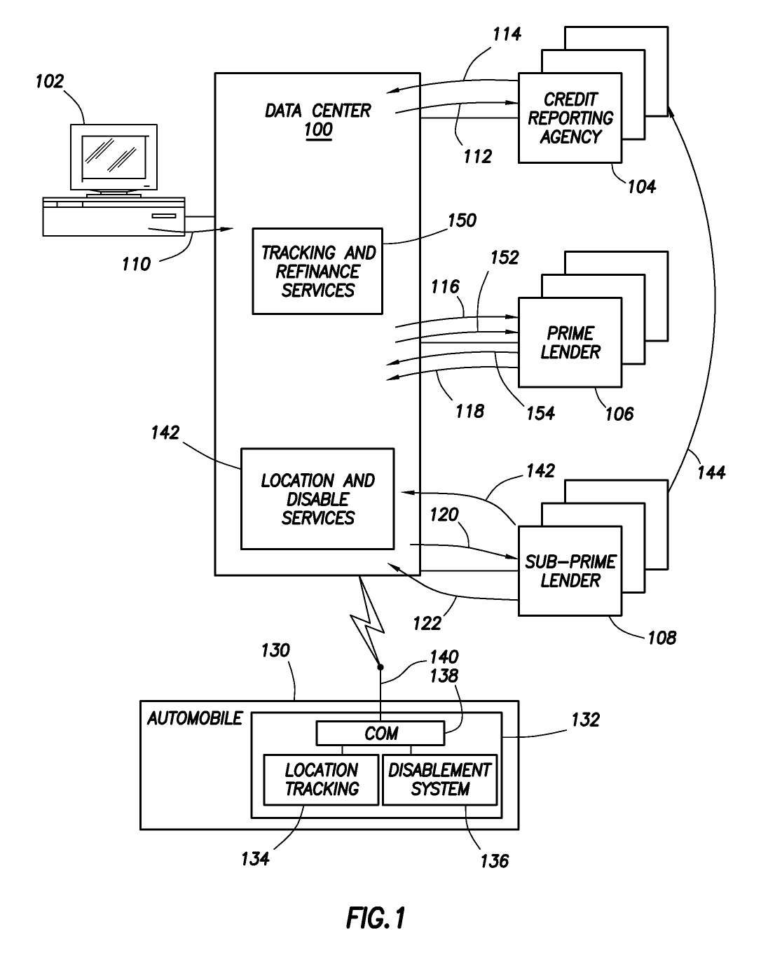

FIG. 1 shows a system in accordance with at least some embodiments. In particular, the system of FIG. 1 comprises a data center 100 coupled to a borrower computer 102, one or more credit reporting agencies 104, one or more prime lenders 106, and one or more sub-prime lenders 108. The data center 100 may comprise one or more computer systems executing software instructions. In some cases, the one or more computer systems of the data center may all be located at a single location; however, in other cases the computer systems of the data center may be remotely located from one another, yet functioning as a data center. In a particular embodiment, one or more computer systems of the data center may be “cloud” computer systems provided under contract from a cloud computing service provider, thus the physical location of the computer systems may not be precisely known to the data center operator, or may change daily or even hourly depending on the amount of computing resources used.

A borrower that desires to purchase an automobile may electronically submit a loan application by way of a borrower computer 102. The borrower computer 102, while shown as a desktop computer, may take many forms. In some cases the borrower computer 102 is a computer system owned by the borrower, such as a desktop or laptop computer in the borrower's home. In other cases, the borrower computer 102 may be a mobile computing device, such as smart phone (i.e., cellular telephone that also runs a mobile operating system and executes user specified programs). In yet still other cases, the borrower computer 102 may be a kiosk at a public location (e.g., shopping mall, automobile dealership) where the borrower may submit a loan application. In yet still additional cases, the borrower may submit a loan application at a public location without the assistance of others at, or near, the borrower computer 102. The borrower computer 102 may couple to the data center by way any suitable communication systems, such as direct connection, by way of the Internet, wireless connection, or combinations. Thus, in many cases the borrower computer 102 is remotely located from the data center 100.

The information within the loan application electronically submitted by the borrower to the data center comprises information that may be useful in determining the creditworthiness of the borrower. The information may comprise: name of the borrower; address; job history; social security number; data of birth; and a list of other recurring payments obligations of the borrower. Electronic submission of the loan application to the data center is illustrated by arrow 110.

The data center 100, in turn, accepts the electronic submission of the loan application for the automobile loan. Based on the loan application, the data center calculates, determines, and/or derives an indication of the creditworthiness of the borrower. In a particular embodiment, the indication of creditworthiness is based, at least in part, on information requested and received from the one or more credit reporting agencies 104. The request and receipt of information from the one or more credit reporting agencies is illustrated by arrows 112 and 114, respectively. The one or more credit reporting agencies 104 may be, for example: Equifax Credit Information Services, Inc.; Trans Union, LLC; or Experian Information Solutions, Inc. Other examples of credit reporting agencies include any person or entity that has information regarding a history of payments on debts owed or previously owed by the borrower.

In some cases, particularly cases of the commercial credit reporting agencies, the indication of creditworthiness may come in the form of statistically calculated number, sometimes referred as the FICO® score, where FICO® is trademark of the Fair Isaac Corporation. The balance of the specification will refer to a numerical score as a credit score, but such should not be read as a limitation as the applicability of the various embodiments described. In most cases, credit scores range from a credit score of 300 to a credit score of 850. Borrowers with a credit score above about 630 are considered “prime” candidates, and those with a credit score below about 630 are considered “sub-prime” candidates. In some cases the “sub-prime” candidates have credit scores between about 380 and 630. The “prime” and “sub-prime” example categories should not be confused with, and have no relation to, the prime lending rate.

Thus, the data center accepts the electronically submitted loan application, gathers additional information from the credit reporting agencies, and analyzes the information to determine how to proceed. In the case of borrowers that fall into to the prime category (e.g., credit score greater than 630), the software of the data center 100 may provide the loan application information and credit score to the prime lenders 106. The prime lenders may take any suitable form, such as banks, credit unions, or specially focused financing companies (e.g., General Motors Acceptance Corporation (GMAC), Ford Motor Credit). In some cases, the prime lenders may compete for the loan, by offering loans with varying terms (e.g., interest rate). Sending of the information from the data center to the prime lenders 106, and return of loan offers from the lenders 106, is illustrated by arrows 116 and 118, respectively. The borrower may then choose among the competing offers, as gathered and presented by the software executing on the data center 100. With a lender identification and selection facilitated by the data center 100, the borrower may then purchase an automobile from an automobile dealer, with the purchase financed through the selected prime lender 106. Other than the selected lender having a lien on the automobile, in some embodiments no other physical requirements are specified by the lender with respect to the purchase of the automobile.

However, many borrowers that electronically submit loan applications to the data center 100 may fall into the sub-prime category of borrower, which sub-prime category again may be borrowers with credit scores below 630, and more particularly borrowers with credit scores between 380 and 630. In the past, such sub-prime borrowers were rejected, either by the data center 100 directly, or by way of the prime lenders 106 refusing to quote loan transactions. However, in an effort to help the borrower increase the borrower's credit score, and in accordance with the various embodiments, the software of the data center 100 may pair sub-prime candidates with sub-prime lenders 108, along with physical requirements with respect to the purchase of the automobile.

In the case of borrowers that fall into to the sub-prime category (e.g., credit score less than 630), the software of the data center 100 may provide the loan application information and credit score to the sub-prime lenders 108. In some cases, the sub-prime lenders may compete for the loan, by offering loans with varying terms (e.g., interest rate, payment frequency). Sending of the information from the data center to the sub-prime lenders 108, and return of loan offers from the sub-prime lenders 108, is illustrated by arrows 120 and 122 respectively. However, in each case with respect to sub-prime borrowers, loan offerings include a requirement that the automobile purchased include a device that can provide at least location information on request, and in some cases the on-board device can disable the vehicle on command (e.g., in the event of non-payment or other loan default condition). With a sub-prime lender 108 identified and selected through the data center 100, the borrower may then purchase an automobile from an automobile dealer, with the purchase financed through the selected sub-prime lender 108, with the on-board device either present or installed prior to possession by the borrower.

The sub-prime lenders may take any suitable form, such as banks, credit unions, or specially focused financing companies. In many cases, however, the sub-prime lenders 108 may be the automobile dealers themselves, or a financing entity directly associated with the automobile dealer. In some cases, such sub-prime lenders 108 may be referred to as “buy here, pay here” dealerships. However, in other embodiments the sub-prime lender 108 need not be associated in any way with the automobile dealership from whom the automobile is purchased.

In the case of the sub-prime borrower, the automobile with the on-board device is illustrated in FIG. 1. In particular, the automobile 130 (in block diagram form) is shown to have an on-board device 132. The on-board device 132 illustratively comprises a location tracking system 134, a disablement system 136, and a communication (“Com”) system 138. The communication system 138 may take any suitable form, and in a particular embodiment the communication system 138 communicates wirelessly with the data center 100, as illustrated by antenna 140. In one embodiment, the communication system 138 is a system that communicates with the data center over a cellular telephone network. In another embodiment, the communication system 138 may communicate with the data center 100 over a satellite communication system.

The location tracking system 134 of the on-board device 132 is a system that can determine the location of the automobile. In some embodiments, the location tracking system 134 uses the Global Positioning System (GPS) satellite signals to determine position. In other embodiments, the location tracking system 134 may determine position by triangulation of signals from cellular towers. In yet still other cases, the location tracking system 134 may use a combination of surface based fixed stations and orbiting GPS satellites to determined location.

The disablement system 136 of the on-board device 132 is a system that can selectively disable the vehicle. Disablement may take many forms. In some cases the disablement is by disabling the starter mechanism. In other cases, disablement of the automobile may be accomplished by way of any suitable system, such as the fuel system (e.g., disabling the electrically controlled fuel pump) or the engine electrical system (e.g., disabling the ignition system). On-board device 132 may be part of the original equipment of the automobile, or may be an after-market product, such as the PASSTIME® brand products available from Gordon*Howard Associates, Inc. of Littleton, Colo.

The location tracking system 134 and disablement system 136 may be selectively operated on command from the communication system 138. In everyday operation, the location tracking system 134 may remain dormant, and disablement system 136 enables the automobile to operate normally. However, on command from software of the data center 100, one or both of the services may be invoked. In particular, the data center 100 may comprise location and disable services 142. The location and disable services 142 may be one or more programs executed on one or more computer systems. At the request of any authorized entity (e.g., one of the lenders 106, 108), the location of the automobile may be determined, or the automobile disabled. Because the automobile is easier to locate and disable with the on-board device 132 present, and thus easier to recover in the event of loan default, the amount of risk carried by the sub-prime lender is reduced.

Still referring to FIG. 1, in accordance with at least some embodiments, the sub-prime lender 108 that finances a sub-prime borrower reports information regarding loan payments made by the borrower. The reporting of information regarding loan payments is illustrated by arrow 142. In some cases, the sub-prime lender 108 may report the information regarding loan payments without a contractual obligation to do so; however, in a particular embodiment in order to participate in the system provided by the data center of matching borrowers with the lenders, the sub-prime lenders 108 will have a contractual obligation to report the information regarding the loan payments, either to the data center 100, or in another embodiment directly to one or more of the credit reporting agencies 104, as illustrated by arrow 144. In other cases, the sub-prime lender 108 will report information regarding loan payments to the data center 100, and software of the data center, in turn, will report the information to the credit reporting agencies 104. Outside the context the various embodiments discussed herein, sub-prime lenders in the form of “buy here, pay here” automobile dealerships have no obligation to report timely loan payments to a credit reporting agency

Data center 100 further comprises tracking and refinance services 150. The tracking and refinance services 150 may be one or more software programs executed on one or more computer systems of the data center. Assuming consistent loan payments by the borrower, the borrower's credit score may increase with time, possibly with each timely loan payment. The data center 100 thus tracks information regarding loan payments made by the borrower. Tracking the loan payments may be by way of receiving the information directly from sub-prime lender (arrow 142), or by follow-up communications with one or more of the credit reporting agencies 104. The tracking and refinance services 150 may thus determine that the credit score of the borrower has risen above a predetermined threshold (e.g., credit score of 630).

Consider first the situation where the borrower is still making payments on the first automobile purchased. If the borrower's credit score has risen above the predetermined threshold, the software 150 of the data center 100 may provide the previously provided loan information, along with the current credit score and any other suitable information, to the prime lenders 106. Based on the information provided, the prime lenders 106 may send refinancing loan offers to the data center 100. Sending of the information from the data center to the prime lenders 106, and return of loan offers from the lenders 106, is illustrated by arrows 152 and 154, respectively. The borrower may then choose among the competing refinance offers, as gathered and presented by the software executing on the data center 100. With a lender identification and selection facilitated by the data center 100, the borrower may then refinance the automobile through the selected prime lender 106. In some cases, the selected terms of the refinancing do not require continued activation of the on-board device 132. In other cases, the selected terms of the refinancing require continued activation of the on-board device 132, but continued activation of such a device may result in more favorable terms (e.g., a lower interest rate than if the on-board device 132 is not activated).

Consider next the situation where the borrower is still making payments on the first automobile purchased, where the borrower would be favorably disposed to “upgrade” the automobile driven, but where the borrower does not want an on-board device 132. If the borrower's credit score has risen above the predetermined threshold, the software 150 of the data center 100 may provide the previously provided loan information, along with the current credit score and any other suitable information, to the prime lenders 106. Based on the information provided, the prime lenders 106 may send loan offers to the data center 100, the loan offers to purchase a second automobile (and possibly based on the assumption that the first automobile is traded-in). Sending of the information from the data center to the prime lenders 106, and return of loan offers from the lenders 106, is again illustrated by arrows 152 and 154, respectively. The borrower may then choose among the competing refinance offers, as gathered and presented by the software executing on the data center 100. With a lender identification and selection facilitated by the data center 100, the borrower may then purchase the second automobile from an automobile dealer, with the purchase financed through the selected prime lender 106. In a particular embodiment, the second loan does not require the second automobile to comprise an on-board device 132.

Consider next the situation where the borrower is still making payments on the first automobile purchased, but where the borrower would be favorably disposed to “upgrade” the automobile driven and the borrower is not adverse to the presence of an on-board device that can track location of the automobile. If the borrower's credit score has risen above the predetermined threshold, the software 150 of the data center 100 may provide the previously provided loan information, along with the current credit score and any other suitable information, to the prime lenders 106. Based on the information provided, the prime lenders 106 may send loan offers to the data center 100, the loan offers to purchase a second automobile but with a requirement than the second automobile purchased have an on-board device that can track location of the automobile. Sending of the information from the data center to the prime lenders 106, and return of loan offers from the lenders 106, is again illustrated by arrows 152 and 154, respectively. At least because the borrower's credit score has increased and the requirement for an on-board device that can track the automobile, the interest rate of the various loan offers should be lower than the interest rate for the loan on the first automobile. The borrower may then choose among the competing loan offers, as gathered and presented by the software executing on the data center 100. With a lender identification and selection facilitated by the data center 100, the borrower may then purchase the second automobile from an automobile dealer, with the purchase financed through the selected prime lender 106, and with the on-board device that can track location of the automobile either present or installed prior to possession by the borrower. Because the risk is lower in the situations where location of the vehicle can be tracked, the interest rate (and possibly other loan terms) may be more favorable for the borrower than the situation of the second loan for the second automobile with no on-board tracking device.

Consider next the situation where the borrower is still making payments on the first automobile purchased, but where the borrower would be favorably disposed to “upgrade” the automobile driven and the borrower is not adverse to the presence of an on-board device than can track and disable the automobile. If the borrower's credit score has risen above the predetermined threshold, the software 150 of the data center 100 may provide the previously provided loan information, along with the current credit score and any other suitable information, to the prime lenders 106. Based on the information provided, the prime lenders 106 may send loan offers to the data center 100, the loan offers to purchase a second automobile but with a requirement than the second automobile purchased have an on-board device that can track and disable the automobile. Sending of the information from the data center to the prime lenders 106, and return of loan offers from the lenders 106, is again illustrated by arrows 152 and 154, respectively. At least because the borrower's credit score has increased and the requirement for an on-board device that can track and disable the automobile, the interest rate of the various loan offers should be lower than the interest rate for the loan on the first automobile, and lower than the interest rate for purchase of an automobile with either no on-board device, or an on-board device with tracking but not disablement capability. The borrower may then choose among the competing loan offers, as gathered and presented by the software executing on the data center 100. With a lender identification and selection facilitated by the data center 100, the borrower may then purchase the second automobile from an automobile dealer, with the purchase financed through the selected prime lender 106, and with an on-board device that can track and disable the automobile either present or installed prior to possession by the borrower.

The various embodiments discussed to this point regarding financing of the second automobile have assumed that the borrower's disposition regarding an on-board device with tracking, and possibly disablement, capability is known prior to making the loan offers. However, in some embodiments such information is not known, and thus the offers presented from prime lenders may include varying terms regarding presence and/or capability of an on-board device. That is, the loan offers from the prime lenders 106, as gathered by the data center 100, may include loan offers with no requirement for an on-board device, loan offers with the requirement for an on-board device with tracking-only capability, and loan offers with the requirement for an on-board device with tracking and disablement capability. The favorability of the loan terms should be related to the presence or absence of the on-board device, and capabilities of the on-board device. For example, loan offers with no requirement an on-board device may carry higher interest rate than loan offers with a requirement for an on-board device. Likewise, loan offers with the requirement for an on-board device with only tracking capability may carry higher interest rate than loan offers with a requirement for an on-board device with both tracking and disablement capability. The borrower can thus choose the loan and requirements that suits the borrower.

Still referring to FIG. 1, the various embodiments discussed to this point have been based on loan payments made by the borrower and the borrower's credit score; however, the information upon which decisions regarding whether to offer refinancing, or whether to offer financing for a second automobile, need not be limited to just payments received and credit score. In other embodiments, the on-board device 132 may directly or indirectly provide further information useful in determining the risk associated with a borrower for refinance and/or second loan situations. For example, the on-board device 132, given the ability to track location and/or communicate with the computer system of the automobile, may have the ability to determine the miles travelled by the automobile over any relevant period of time. An automobile driven just a few thousand miles a year may present less risk and more residual value than an automobile driven several tens of thousands of miles a year. Further, the on-board device 132 may have the ability to determine the identity and/or number of drivers of the automobile. An automobile driven consistently by only the borrower may present less risk than an automobile driven by every member of an extended family. Further still, using tracking information from the on-board device 132, the data center 100 may be able to determine locations at which the automobile has been parked. An automobile consistently parked in the borrower's garage may present less risk than an automobile that is parked outside consistently in high crime areas. Moreover, on-board device 132 may have the ability to determine how aggressively the automobile is driven (e.g., by the use of accelerometers). An automobile that is consistently aggressively driven may present more risk and less residual value. Any or all the recited factors may be considered by the prime lenders 106 in developing terms for refinancing and/or second automobile loan offers.

Moreover, the information gathered by the on-board device 132 may affect the refinancing decision in other ways. For example, based on driving habits the value of the car could increase and the borrower's could qualify for, or qualify earlier for, refinancing based on higher values for the trade-in vehicle. Further still, while the values of late models cars seems to always decrease over time, certain occurrence may accelerate the loss in value, such as hitting a major mileage threshold (e.g., 100,000 miles), or an upcoming change in body style. Thus, based on the information from the on-board device 132 and/or other information, the borrower could be notified that a trade-up may be warranted to receive the best value for the trade-in vehicle.

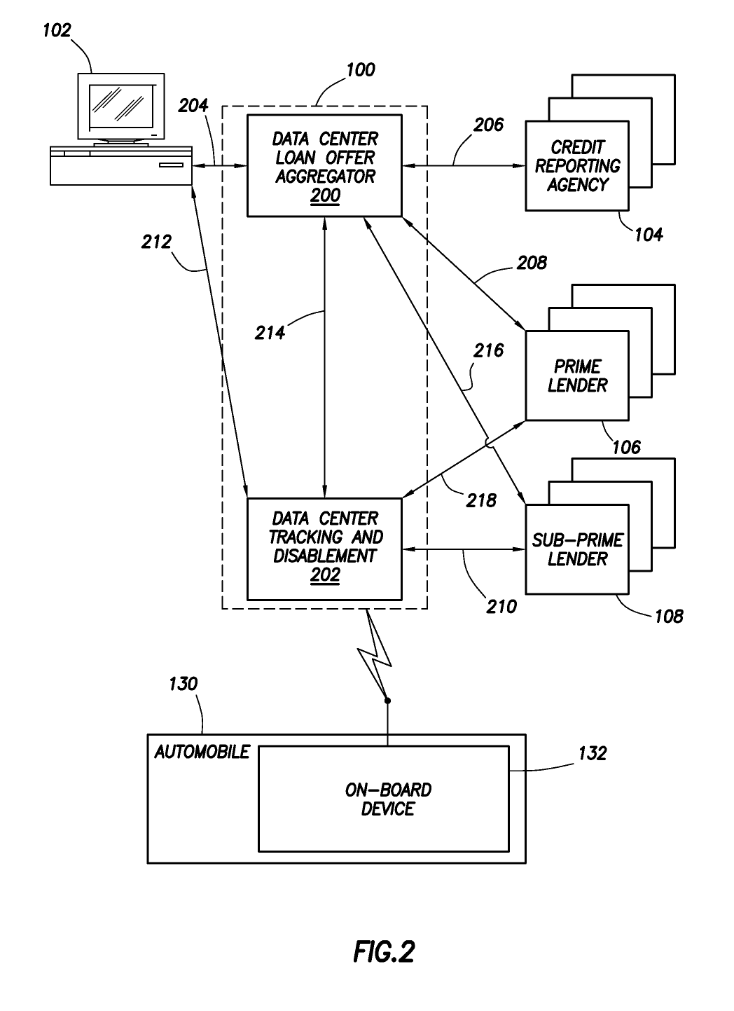

The various embodiments discussed to this point have assumed direct contact between the software of the data center 100 and the subprime lenders 108, as well as the data center 100 being the primary location for tracking and disablement services. However, in other embodiments various distinct legal entities may work in concert to implement the data center 100 operations. For example, FIG. 2 shows a system in accordance with at least some embodiments. In particular, FIG. 2 shows a data center of the loan offer aggregator services (hereafter just “aggregator 200”), and data center for the tracking and disablement services (hereafter just “tracker 202”), with the aggregator 200 and tracker 202 making up the overall data center 100. The borrower computer 102 communicates with the aggregator 200 as discussed above, and as illustrated by arrow 204. The aggregator 200 may then make a determination as to whether the borrower is a prime borrower, for example, by the aggregator 200 communicating with the credit reporting agencies 104, as illustrated by arrow 206. The aggregator 200 may solicit various loan offers from the prime lenders 106, as illustrated by arrow 208.

If the borrower is a sub-prime borrower, the aggregator 200 may pass the borrower's loan application information to the tracker 202 entity. The tracker 202, in addition to having software and hardware to communicate with the on-board devices (e.g., on-board device 132 associated with automobile 130), may also be the entity through which the loan application information is communicated to one or more sub-prime lenders 108. Communication between the tracker 202 entity and the sub-prime lenders 108 is illustrated by arrow 210. The tracker 202 entity may be aware, or better aware, of sub-prime lenders 108 who are willing to finance automobile loans for sub-prime borrowers in situations where the automobile has an on-board device 132. Thus, the tracker 202 entity may act, in part, as an aggregator of loan offers from the sub-prime lenders 108, and present those offers to the borrower either directly (as illustrated by arrow 212), or present the offers through the aggregator 200 (as illustrated by arrow 214).

As before, the sub-prime lender 108 reports information regarding loan payments. The information regarding loan payments may be provided to the tracker 202 entity, the aggregator 200 (as illustrated by arrow 216), directly the credit reporting agencies, or some combination. After a certain number of loan payments, the aggregator 200 may determine that the borrower's credit score has increased sufficiently for the borrower to be a prime borrower, and thus the aggregator 200 may solicit offers to refinance, or to finance a second automobile, from the prime lenders 106 with various options as discussed above. In the event the borrower selects a loan (refinance or loan for second automobile) that includes an on-board device, the prime lender 106 may communicate with the tracker entity 202, as illustrated by arrow 218.

Thus, by a proactive system implemented by way of the data center 100, and consistent loan payments by the borrower, a borrower's credit score can be increased with financing eventually through a prime lender. It is noted that in some cases the borrower may make a second loan application to trigger the process of refinancing or financing a second automobile, but in other cases the data center 100 (particular the aggregator 200) may actively monitor the borrower's credit, and make initial contact with the borrower on the refinance and/or second automobile loan offers without the borrower submitting a second application. That is, the second offer may be unsolicited by the borrower.

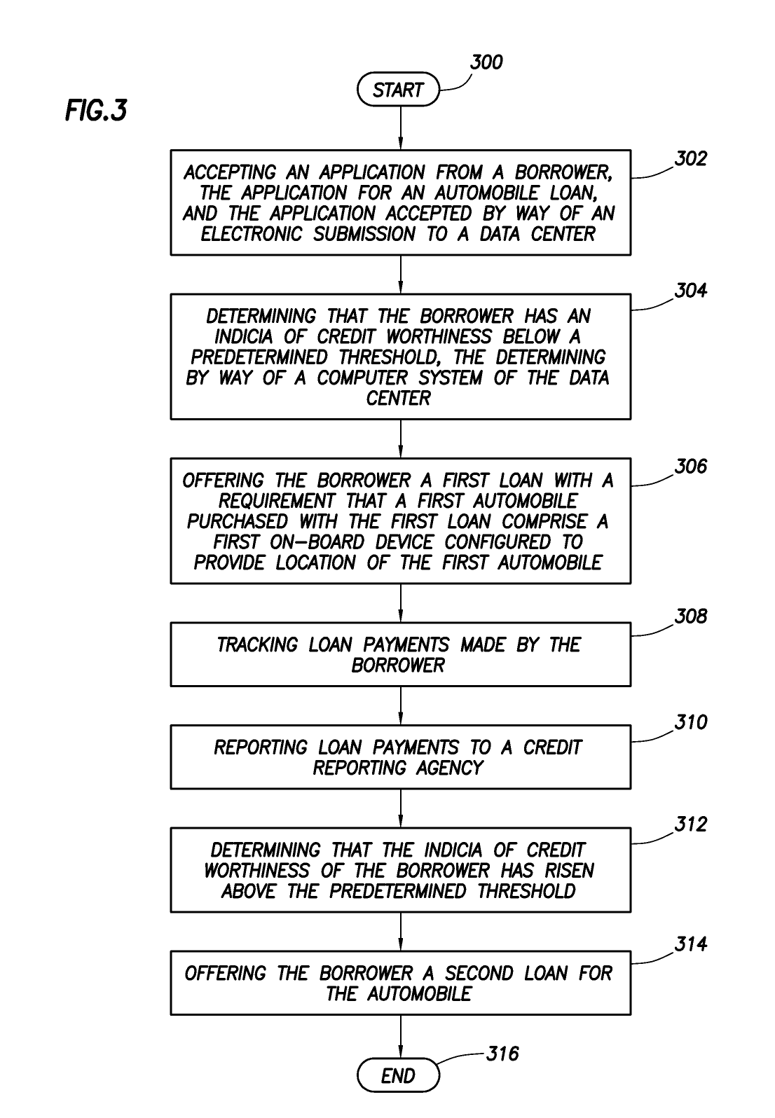

FIG. 3 shows a method in accordance with at least some embodiments. The illustrative method steps may be implemented, in at least some embodiments, by way of software executing on a computer system. In particular, the method starts (block 300) and comprises: accepting an application from a borrower, the application for an automobile loan, and the application accepted by way of an electronic submission to a data center (block 302); determining that the borrower has an indicia of credit worthiness below a predetermined threshold, the determining by way of a computer system of the data center (block 304); offering the borrower a first loan with a requirement that a first automobile purchased with the first loan comprise a first on-board device configured to provide location of the first automobile (block 306); tracking loan payments made by the borrower (block 308); reporting loan payments to a credit reporting agency (block 310); determining that the indicia of credit worthiness of the borrower has risen above the predetermined threshold (block 312); and offering the borrower a second loan for a second automobile (block 314). In some cases the terms of the second loan do not require the second automobile have an on-board device configured to track location. In other cases the terms of the second loan require the second automobile have an on-board device configured to track location and/or to disable the automobile, but the interest rate for the loan is lower accounting for the reduced risk on the part of the lender. Thereafter, the method ends (block 316).

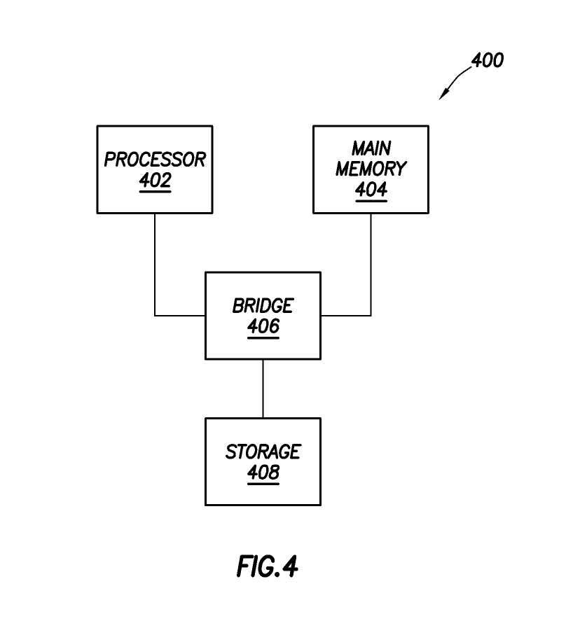

FIG. 4 illustrates a computer system 400 in accordance with at least some embodiments, and upon which at least some of the various embodiments may be implemented. That is, some or all of the various embodiments may execute on a computer system such as shown in FIG. 4, multiple computers systems such as shown in FIG. 4, and/or one or more computer systems equivalent to the FIG. 4, including after-developed computer systems.

In particular, the computer system 400 comprises a processor 402, and the processor couples to a main memory 404 by way of a bridge device 406. In some embodiments, the bridge device may be integrated with the processor 402. Moreover, the processor 402 may couple to a long term storage device 408 (e.g., a hard drive) by way of the bridge device 406. Programs executable by the processor 402 may be stored on the storage device 408, and accessed when needed by the processor 402. The programs stored on the storage device 408 may comprise programs to implement the various embodiments of the present specification, including accepting loan applications, determining credit worthiness, offering loans to the borrower, tracking loan payments, reporting loan payments determining an increase in credit worthiness, and offering further loans at better terms. In some cases, the programs are copied from the storage device 408 to the main memory 404, and the programs are executed from the main memory 404. Thus, both the main memory 404 and storage device 408 are considered non-transitory computer-readable storage mediums.

In the specification and claims, certain components may be described in terms of algorithms and/or steps performed by a software application that may be provided on a non-transitory storage medium (i.e., other than a carrier wave or a signal propagating along a conductor).

The various embodiments also relate to a system for performing various steps and operations as described herein. This system may be a specially-constructed device such as an electronic device, or it may include one or more general-purpose computers that can follow software instructions to perform the steps described herein. Multiple computers can be networked to perform such functions. Software instructions may be stored in any computer readable storage medium, such as for example, magnetic or optical disks, cards, memory, and the like.

References to “one embodiment”, “an embodiment”, “a particular embodiment” indicate that a particular element or characteristic is included in at least one embodiment of the invention. Although the phrases “in one embodiment”, “an embodiment”, and “a particular embodiment” may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. For example, various embodiments can be applied to any movable asset, including but not limited to motor vehicles other than automobiles such as airplanes, boats, motorcycles, personal watercraft and the like. It is intended that the following claims be interpreted to embrace all such variations and modifications.

What is claimed is:

1. A method comprising:
accepting an application from a borrower, the application for a motor vehicle loan, and the application accepted by way of an electronic submission to a data center;
determining that the borrower has an indicia of credit worthiness below a predetermined threshold, the determining by way of a computer system of the data center;
offering the borrower a first loan with a requirement that a first motor vehicle purchased with the first loan comprise a first on-board device configured to provide location of the first motor vehicle; and if the borrower accepts
tracking the loan payments made by the borrower, the tracking by way of a computer system; and
reporting loan payments to a credit reporting agency, the reporting by way of a computer system.

2. The method of claim 1 wherein determining that the borrower has an indicia of credit worthiness below the predetermined threshold further comprises electronically requesting the indicia of credit worthiness from a credit reporting agency.

3. The method of claim 1 wherein determining that the borrower has an indicia of credit worthiness below the predetermined threshold further comprises determining that a credit score of the borrower is below about 650.

4. The method of claim 3 wherein determining that the borrower's credit score is below the predetermined threshold further comprises determining that the credit score of the borrower is between about 380 and 650.

5. The method of claim 1 wherein offering the borrower the first loan further comprises offering the borrower the first loan with the requirement that the first on-board device is configured to disable the first motor vehicle.

6. The method of claim 1 further comprising, after a predetermined number of loan payments have been made by the borrower:
determining that the indicia of credit worthiness of the borrower has risen above the predetermined threshold, the determining by a computer system of the data center; and
offering the borrower a second loan for a second motor vehicle, the second loan does not require the second motor vehicle to comprise an on-board device that is configured to track location of the second motor vehicle.

7. The method of claim 1:
wherein offering the borrower the first loan further comprises offering the first loan at a first interest rate; and
after a predetermined number of loan payments have been made by the borrower on the first loan
determining that the indicia of credit worthiness of the borrower has risen above the predetermined threshold, the determining by a computer system of the data center; and
offering the borrower a second loan for a second motor vehicle with a requirement that the second motor vehicle comprise a second on-board device that is configured to track location of the second motor vehicle, the second loan at a second interest rate lower than the first interest rate.

8. The method of claim 7 wherein offering the borrower the second loan further comprises offering the borrower the second loan with the requirement that the second on-board device is configured to disable the second motor vehicle.

9. The method of claim 7 further comprising, simultaneously with offering the borrower the second loan, offering the borrower a third loan for the second motor vehicle with a requirement that the second motor vehicle comprise the second on-board device that is configured to disable the second motor vehicle, the third loan at a third interest rate lower than the first interest rate and lower than the second interest rate.

10. The method of claim 1 wherein reporting loan payments to a credit reporting agency further comprises reporting the loan payments by a computer system of the data center.

11. The method of claim 1 wherein reporting loan payments to a credit reporting agency further comprises reporting the loan payments by a computer system not associated with the data center.

12. The method of claim 1 further comprising, after a predetermined number of loan payments have been made by the borrower:
determining indicia of risk associated with the borrower, the determining by a computer system of the data center communicating with the first on-board device, the indicia of risk comprising at least one selected from the group consisting of: miles travelled over a period of time by the first motor vehicle, identity of the drivers of the first motor vehicle, locations at which the first motor vehicle has been parked, indication of a degree to which the first motor vehicle has been aggressively driven, and indication of trade-in value of the first motor vehicle; and
offering the borrower a second loan for a second motor vehicle, the second loan does not require the second motor vehicle to comprise an on-board device that tracks location of the second motor vehicle.

13. A method comprising:
accepting an application from a borrower, the application for a motor vehicle loan, and the application accepted by way of an electronic submission to a data center;
determining that the borrower has an indicia of credit worthiness below a predetermined threshold, the determining by way of a computer system of the data center;
offering the borrower a first loan with a requirement that a first motor vehicle purchased with the first loan comprise a first on-board device configured to disable the first motor vehicle; and if the borrower accepts
tracking the loan payments made by the borrower, the tracking by way of a computer system; and
reporting loan payments to a credit reporting agency, the reporting by way of a computer system.

14. The method of claim 13 wherein determining that the borrower has an indicia of credit worthiness below the predetermined threshold further comprises electronically requesting the indicia of credit worthiness from a credit reporting agency.

15. The method of claim 13 wherein determining that the borrower has an indicia of credit worthiness below the predetermined threshold further comprises determining that a credit score of the borrower is below about 650.

16. The method of claim 13 wherein offering the borrower the first loan further comprises offering the borrower the first loan with the requirement that the first on-board device is configured to track the first motor vehicle.

17. The method of claim 13 further comprising, after a predetermined number of loan payments have been made by the borrower:
determining that the indicia of credit worthiness of the borrower has risen above the predetermined threshold, the determining by a computer system of the data center; and
offering the borrower a second loan for a second motor vehicle, the second loan does not require the second motor vehicle to comprise an on-board device configured to disable the second motor vehicle.

18. The method of claim 13:
wherein offering the borrower the first loan further comprises offering the first loan at a first interest rate; and
after a predetermined number of loan payments have been made by the borrower on the first loan
determining that the indicia of credit worthiness of the borrower has risen above the predetermined threshold, the determining by a computer system of the data center; and
offering the borrower a second loan for a second motor vehicle with a requirement that the second motor vehicle comprise a second on-board device that is configured to disable location of the second motor vehicle, the second loan at a second interest rate lower than the first interest rate.

19. The method of claim 18 wherein offering the borrower the second loan further comprises offering the borrower the second loan with the requirement that the second on-board device is configured to track the second motor vehicle.

20. The method of claim 18 further comprising, simultaneously with offering the borrower the second loan, offering the borrower a third loan for the second motor vehicle with a requirement that the second motor vehicle comprise the second on-board device that is configured to track the second motor vehicle, the third loan at a third interest rate lower than the first interest rate and lower than the second interest rate.

21. The method of claim 13 wherein reporting loan payments to a credit reporting agency further comprises reporting the loan payments by a computer system of the data center.

22. The method of claim 13 wherein reporting loan payments to a credit reporting agency further comprises reporting the loan payments by a computer system not associated with the data center.

23. The method of claim 13 further comprising, after a predetermined number of loan payments have been made by the borrower:
determining indicia of risk associated with the borrower, the determining by a computer system of the data center communicating with the first on-board device, the indicia of risk comprising at least one selected from the group consisting of: miles travelled over a period of time by the first motor vehicle, identity of the drivers of the first motor vehicle, locations at which the first motor vehicle has been parked, indication of a degree to which the first motor vehicle has been aggressively driven; and
offering the borrower a second loan for a second motor vehicle, the second loan does not require the second motor vehicle to comprise an on-board device configured to disable of the second motor vehicle.

24. A non-transitory computer-readable medium storing a program that, when executed by one or more processors associated with a data center, causes the one or more processors to:
receive an application from a borrower, the application for a motor vehicle loan;
determine the borrower has indicia of credit worthiness below a predetermined threshold;
send a first loan offer to the borrower, the first loan offer a first interest rate and with a requirement that a first motor vehicle purchased with a first loan comprise a first on-board device that is at least one selected from the group consisting of: configured to track location of the first motor vehicle, and configured to disable the first motor vehicle;
report loan payments on the first loan to a credit reporting agency, the reporting by way of a computer system; and after a predetermined number of loan payments have been made by the borrower
determine that the indicia of credit worthiness of the borrower has risen above the predetermined threshold; and then
send a second offer to the borrower for a second loan for a second motor vehicle, the second offer unsolicited by the borrower, and the second loan at a second interest rate lower than the first interest rate.

25. The non-transitory computer-readable medium of claim 24 wherein when the one or more processors send the second offer, the program further causes the one or more processors to send the second offer for the second loan with no a requirement that the second motor vehicle comprises an on-board that tracks location or disables the second motor vehicle.

26. The non-transitory computer-readable medium of claim 24 wherein when the one or more processors send the second offer, the program further causes the one or more processors to send the second offer for the second loan with a requirement that the second motor vehicle comprises a second on-board device configured to track location of the second motor vehicle, but does not disable the second motor vehicle.

27. The non-transitory computer-readable medium of claim 24 wherein when the one or more processors send the second offer, the program further causes the one or more processors to send the second offer for the second loan with a requirement that the second motor vehicle comprises a second on-board device configured to disable the second motor vehicle, but does not track disable the second motor vehicle.

28. The non-transitory computer-readable medium of claim 24 wherein when the one or more processors determine the borrower has an indicia of credit worthiness below a predetermined threshold, the program causes the one or more processors to determine that the borrower has a credit score below about 650.

29. The non-transitory computer-readable medium of claim 28 wherein when the one or more processors determine the borrower has a credit score below a predetermined threshold, the program causes the one or more processors to determine that the borrower has a credit score between about 380 and 650.

30. The non-transitory computer-readable medium of claim 24 where when the one or more processors determine the indicia of credit worthiness of the borrower has risen, the program further causes the processor to determine an indicia of risk associated with the borrower, the indicia of risk comprising at least one selected from the group consisting of: miles travelled over a period of time by the first motor vehicle; identity of drivers of the first motor vehicle; locations at which the first motor vehicle has been parked; and an indication of a degree to which the first motor vehicle has been aggressively driven.

31. A method comprising:
accepting an application from a borrower at a computer at a public location, the application accepted by way of an electronic submission to a data center;
determining that the borrower has an indicia of credit worthiness below a predetermined threshold, the determining by way of a computer system of the data center;
offering the borrower a first loan with a requirement that a first movable asset purchased with the first loan comprise a first device configured to provide location of the first movable asset; and if the borrower accepts
tracking the loan payments made by the borrower, the tracking by way of a computer system; and
reporting loan payments to a credit reporting agency, the reporting by way of a computer system.

32. The method of claim 1 wherein determining that the borrower has an indicia of credit worthiness below the predetermined threshold further comprises electronically requesting the indicia of credit worthiness from a credit reporting agency.

33. The method of claim 1 wherein determining that the borrower has an indicia of credit worthiness below the predetermined threshold further comprises determining that a credit score of the borrower is below about 650.

34. The method of claim 33 wherein determining that the borrower's credit score is below the predetermined threshold further comprises determining that the credit score of the borrower is between about 380 and 650.

35. The method of claim 31 further comprising, after a predetermined number of loan payments have been made by the borrower:
determining that the indicia of credit worthiness of the borrower has risen above the predetermined threshold, the determining by a computer system of the data center; and
offering the borrower a second loan for a second movable asset, the second loan does not require the second movable asset to comprise a device that is configured to track location of the second movable asset.

36. The method of claim 31:
wherein offering the borrower the first loan further comprises offering the first loan at a first interest rate; and
after a predetermined number of loan payments have been made by the borrower on the first loan
determining that the indicia of credit worthiness of the borrower has risen above the predetermined threshold, the determining by a computer system of the data center; and
offering the borrower a second loan for a second movable asset with a requirement that the second movable asset comprise a second device that is configured to track location of the second movable asset, the second loan at a second interest rate lower than the first interest rate.

39. The method of claim 31 wherein reporting loan payments to a credit reporting agency further comprises reporting the loan payments by a computer system of the data center.

40. The method of claim 31 wherein reporting loan payments to a credit reporting agency further comprises reporting the loan payments by a computer system not associated with the data center.
